(19) United States
(12) Patent Application Publication
(10) Pub. No.: US 2024/0354644 A1
(43) Pub. Date: Oct. 24, 2024

(54) INFORMATION PROCESSING APPARATUS, INFORMATION PROCESSING METHOD, AND STORAGE MEDIUM

(71) Applicant: NEC Corporation, Tokyo (JP)

(72) Inventor: Kunihiro ITO, Tokyo (JP)

(73) Assignee: NEC Corporation, Tokyo (JP)

(21) Appl. No.: 18/628,910

(22) Filed: Apr. 8, 2024

(30) Foreign Application Priority Data
Apr. 21, 2023 (JP) 2023-070186

(51) Int. Cl. G06N 20/00

(52) U.S. Cl. CPC G06N 20/00

(57) ABSTRACT

An information processing apparatus of the present disclosure includes: a determining unit that determines, based on a decision boundary of a machine learning model that relates to a first attribute value and a second attribute value input to the machine learning model and on target data including the pair of a known value of the first attribute value and an unknown candidate value of the second attribute value, whether the target data is valid as training data for the machine learning model; and an estimating unit that estimates the value of the second attribute value from the candidate value of the second attribute value included by the target data determined to be valid.

### INCORPORATION BY REFERENCE

This application is based upon and claims the benefit of priority from Japanese patent application No. 2023-070186, filed on Apr. 21, 2023, the disclosure of which is incorporated herein in its entirety by reference.

### TECHNICAL FIELD

The present disclosure relates to an information processing apparatus, an information processing method, and a program.

### BACKGROUND ART

For the purpose of privacy risk assessment of a learning model having learned using machine learning or the like, an attribute inference attack that is a technique for inferring data (training data) used at the time of learning based on an output from a learning model after learning is known.

Here, attribute inference is a method of estimating the value of an unknown attribute (target attribute) based on the value of a known attribute of certain data. For example, assume a dataset in which a customer's “annual income and age” and “residence status” such as whether the residence is rented or owned are described. In this case, performing, on data (target data) in which “age” or both “age” and “housing status” are proved to be known attributes, estimation of “annual income” that is the target attribute from the values of the known attributes is attribute inference. Then, in the prior literature, it is reported that, when a machine learning model is referred to, the success probability of attribute inference on target data in a dataset used for training (training dataset) increases.

For example, Non-Patent Literature 1 describes a method of outputting a likely value of an unknown attribute by inputting a known attribute and a true label of target data and executing a predetermined process using information derived from a learning model. Here, the label is an objective variable that is an answer to a learning task. Specifically, an unknown attribute that is the inference target is fixed at a certain value to be used as a realization candidate, and an estimation label output by a learning model when the realization candidate is input is calculated. After that, using an assumed error function, likelihood is calculated from the gap between the true label and the estimation label, and the marginal probability of a target attribute is assessed using the calculation result as a weight. Finally, a realization candidate with the largest assessment value is output as the inference result. Non-Patent Literature 1 describes identifying a likely attribute value, for example, by performing a process as described above.

Further, Non-Patent Literature 2 describes identifying a likely attribute value by calculating a weight based on the ratio of the number of data within the decision boundary of a decision tree model, assessing the marginal probability using a calculated gap as a weight, and outputting a realization candidate with the largest assessment value as the inference result.
Non-Patent Literature 1: Fredrikson et. al., Privacy in Pharmacogenetics: An End-to-End Case Study of Personalized Warfarin Dosing, Proceedings of the 23rd USENIX Security Symposium, p. 17-32, 2014
Non-Patent Literature 2: Fredrikson et. al., Model Inversion Attacks that Exploit Confidence Information and Basic Countermeasures, CCS '15: Proceedings of the 22nd ACM SIGSAC Conference on Computer and Communications Security, p. 1322-1333, 2015

However, the techniques described in the prior technique literatures above do not sufficiently consider the structure of a target model, and therefore may output an incorrect candidate as the result of attribute inference. Thus, a model risk assessment apparatus configured based on the prior techniques does not predict an attack that is weaker than that should have been expected, so that there is a problem that a correct risk assessment cannot be performed.

### SUMMARY OF THE INVENTION

Accordingly, an object of the present disclosure is to provide an information processing apparatus that can solve the abovementioned problem that a correct risk assessment of a machine learning model cannot be performed.

An information processing apparatus as an aspect of the present disclosure includes: a determining unit that determines, based on a decision boundary of a machine learning model that relates to a first attribute value and a second attribute value input to the machine learning model and on target data including a pair of a known value of the first attribute value and an unknown candidate value of the second attribute value, whether the target data is valid as training data for the machine learning model; and an estimating unit that estimates a value of the second attribute value from the candidate value of the second attribute value included by the target data determined to be valid.

Further, an information processing method as an aspect of the present disclosure includes: determining, based on a decision boundary of a machine learning model that relates to a first attribute value and a second attribute value input to the machine learning model and on target data including a pair of a known value of the first attribute value and an unknown candidate value of the second attribute value, whether the target data is valid as training data for the machine learning model; and estimating a value of the second attribute value from the candidate value of the second attribute value included by the target data determined to be valid.

Further, a computer program as an aspect of the present disclosure includes instructions for causing a computer to execute processes to: determine, based on a decision boundary of a machine learning model that relates to a first attribute value and a second attribute value input to the machine learning model and on target data including a pair of a known value of the first attribute value and an unknown candidate value of the second attribute value, whether the target data is valid as training data for the machine learning model; and estimate a value of the second attribute value from the candidate value of the second attribute value included by the target data determined to be valid.

With the configurations as described above, the present disclosure enables a correct risk assessment of a machine learning model.

### BRIEF DESCRIPTION OF DRAWINGS

FIG. 1 is a block diagram showing the entire configuration of an information processing system in a first example embodiment of the present disclosure;

FIG. 2 is a block diagram showing the configuration of a risk assessment apparatus disclosed in FIG. 1;

FIG. 3 is a view showing the state of processing by a model storage apparatus disclosed in FIG. 1;

FIG. 4 is a view showing an example of a learning model disclosed in FIG. 1;

FIG. 5 is a view showing an example of the learning model disclosed in FIG. 1;

FIG. 6 is a view showing the state of processing by the risk assessment apparatus disclosed in FIG. 1;

FIG. 7 is a view showing the state of processing by the risk assessment apparatus disclosed in FIG. 1;

FIG. 8 is a flowchart showing the operation of the risk assessment apparatus disclosed in FIG. 1;

FIG. 9 is a block diagram showing the hardware configuration of an information processing apparatus in a second example embodiment of the present disclosure; and

FIG. 10 is a block diagram showing the configuration of the information processing apparatus in the second example embodiment of the present disclosure.

### EXAMPLE EMBODIMENT

### First Example Embodiment

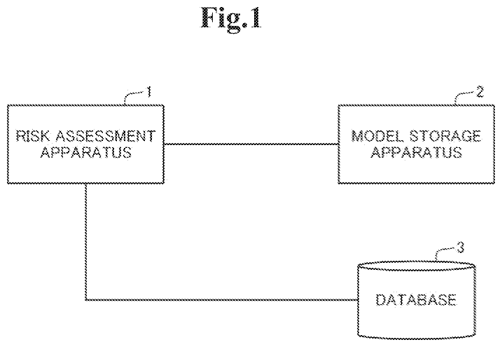

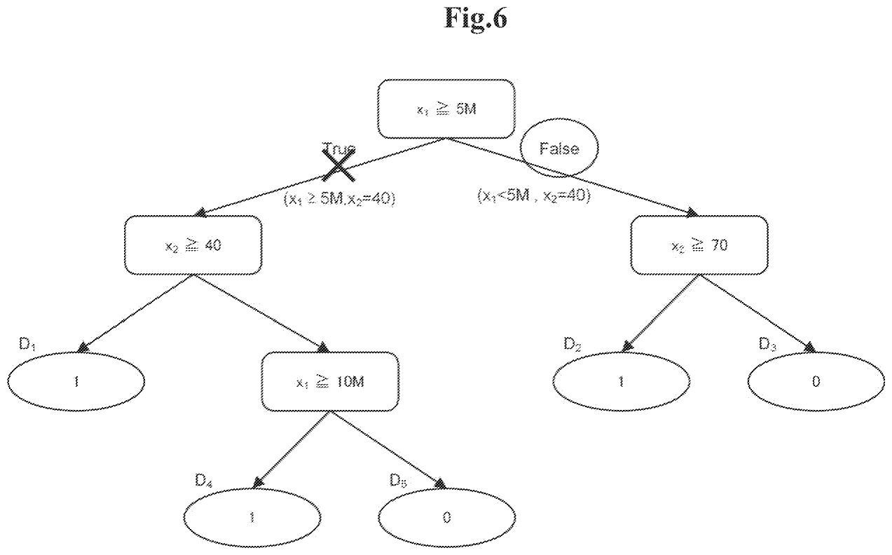

A first example embodiment of the present disclosure will be described with reference to FIGS. 1 to 8. FIGS. 1 to 5 are views for describing the configuration of an information processing system, and FIGS. 6 to 8 are views for describing the processing operation of the information processing system.

### [Configuration]

An information processing system in this example embodiment is configured as shown in FIG. 1 in a manner that a risk assessment apparatus 1, a model storage apparatus 2, and a database 3 are connected via a network. Then, as will be described later, the information processing system is configured in a manner that the risk assessment apparatus 1 performs processing assuming an attribute inference attack with a realistic intensity against a machine learning model stored in the model storage apparatus 2 and can thereby perform a correct risk assessment in the machine learning model. Below, the respective apparatuses will be described in detail.

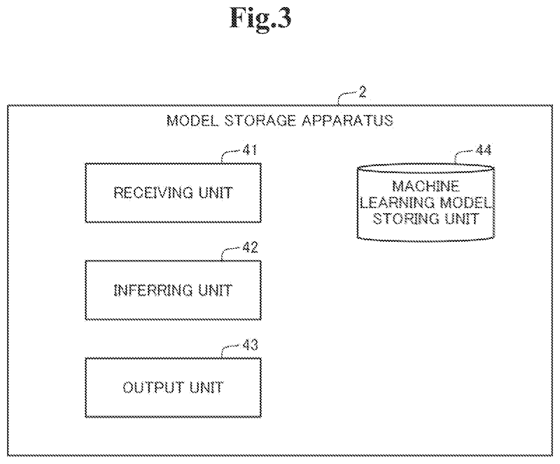

First, the model storage apparatus 2 is configured with one or a plurality of information processing apparatuses each including an arithmetic logic unit and a memory unit. Then, as shown in FIG. 3, the model storage apparatus 2 includes a receiving unit 41, an inferring unit 42, and an output unit 43. The respective functions of the receiving unit 41, the inferring unit 42, and the output unit 43 can be realized by the arithmetic logic unit executing a program for realizing the respective functions stored in the memory unit. The model storage apparatus 2 also includes a machine learning model storing unit 44 configured with the memory unit. Below, the respective components will be described in detail.

The machine learning model storing unit 44 stores a machine learning model to be a risk assessment target in this example embodiment. The machine learning model has been trained in advance using a plurality of training data including a plurality of attributes and labels. The machine learning model may have been trained in the model storage apparatus 2, or may have been trained outside the model storage apparatus 2.

The machine learning model in this example embodiment is a decision tree model (hereinafter, simply referred to as decision tree) as an example. A decision tree is a machine learning model combining a plurality of binary trees (conditional branches) that sorts data by attribute thereof (explanatory variable). Here, in a task to be learned by machine learning or the like, an attribute given as an input is referred to as an explanatory variable, and an output attribute to be the purpose of a learning task is referred to as an objective variable. A machine learning model is formulated with the pair of a decision boundary in an explanatory variable space and output values associated with partial regions of the explanatory variable space partitioned by the decision boundary. Training a machine learning model is learning an appropriate decision boundary. Inference of a machine learning model is performed by applying a learned decision boundary to input data and outputting an appropriate prediction result.

In particular, the decision boundaries of a decision tree are expressed as conditional branches stored in intermediate nodes (condition nodes). A conditional branch is composed of two information: the specification of an attribute used for sorting (attribute specification) and a threshold value to be a branch point for sorting (branch threshold value). In decision tree training, conditional branches that best sort training data are searched for in a brute force manner so that an output value for training data sufficiently explains an objective variable. According to a typical decision tree training algorithm, the branch threshold value of a conditional branch relating to a certain attribute is set to the middle of the attribute values of two data that have different sorting decisions.

Further, inference by a decision tree is performed by sorting input data using the abovementioned conditional branches obtained through training and then outputting the output value of a reached leaf node. When the objective variables are continuous (regression task decision tree), the average value of the objective variables of the data allocated to the leaf node is set as the output value. When the objective variables are discrete (classification task decision tree), the mode of the ratio of the objective variables of the data allocated to the leaf node or the ratio itself is set as the output value.

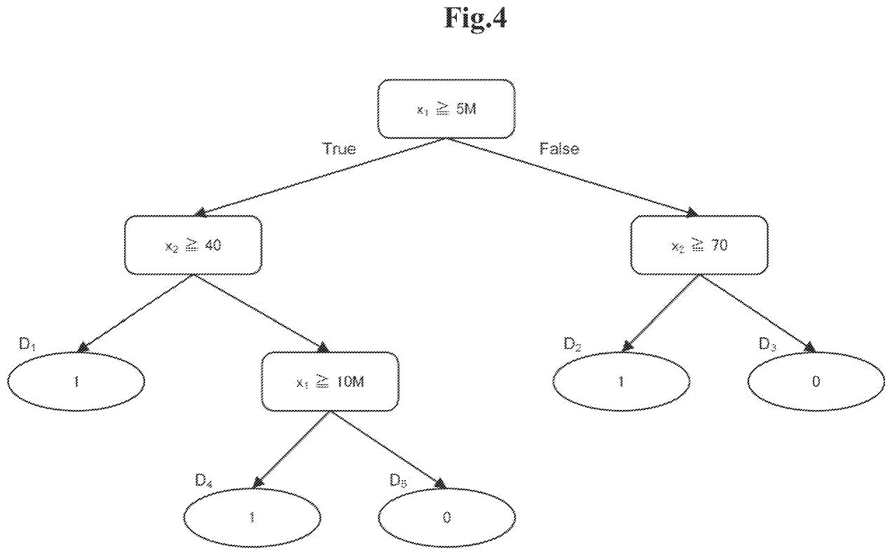

Specifically, the machine learning model in this example embodiment is configured with a decision tree as shown in FIG. 4. As an example, the decision tree in this example embodiment is trained using “age” and “annual income” as explanatory variables and “residence status” such as renting (0) or owning (1) a house as an objective variable. For each condition node in the decision tree, a conditional branch is set along with a threshold value for sorting explanatory variables. For example, in the example of FIG. 4, “5M (5 million yen) or more” is set as a conditional branch related to an explanatory variable “annual income (x₁)” (second attribute value), and “40 (40 years old) or more” or the like is set as a conditional branch related to an explanatory variable “age (x₂)” (first attribute value). Then, by following these conditional branches according to the values of the input explanatory variables, “residence status” located at the leaf node, such as whether renting (0) or owning (1) a house, is inferred.

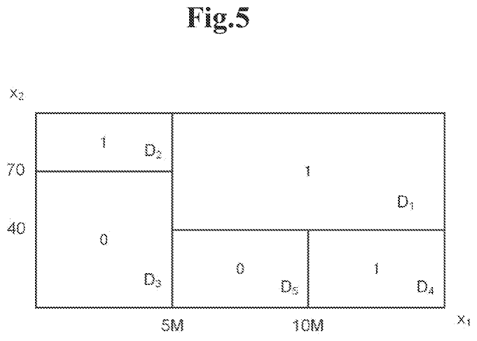

The threshold value of the conditional branch set in the decision tree as described above represents the decision boundary of the decision tree. Here, FIG. 5 illustrates the decision boundaries in the decision tree shown in FIG. 4. As shown in this figure, in a space where the explanatory variables “annual income (x₁)” and “age (x₂)” are taken as the respective axes, divided regions are formed in a manner that the decision boundaries for the explanatory variable “annual income (x₁)” are “5M (5 million yen)” and “10M (10 million yen)” and the decision boundaries for the explanatory variable “age (x₂)” are “40 (40 years old)” and “70 (70 years old)”. The divided regions D₁ to D₅ in FIG. 5 correspond to the leaf nodes in FIG. 4, and each indicate the variable of residence status such as renting (0) or owning (1) a house.

Then, the decision boundaries of the decision tree described above are acquired by the risk assessment apparatus 1 as will be described later. For example, data representing the content of the decision tree shown in FIG. 4 and data of the decision boundaries shown in FIG. 5 may be stored in advance in the risk assessment apparatus 1. Alternatively, as will be described below, the model storage apparatus 2 may output to the risk assessment apparatus 1 in response to a request by the risk assessment apparatus 1. In this case, the respective components of the model storage apparatus 2 function in the following manner.

The receiving unit 41 receives realization candidate data including a known attribute value and a candidate value of an unknown attribute value as will be described later. The receiving unit 41 receives, from the risk assessment apparatus 1, a number of realization candidate data corresponding to the number of candidate values of the unknown attribute value for the risk assessment apparatus 1. The receiving unit 41 may receive information other than that illustrated above, such as identification information, along with the realization candidate data.

The inferring unit 42 inputs each of the realization candidate data received by the receiving unit 41 to a decision tree that is a machine learning model. Moreover, the inferring unit 42 acquires a decision boundary corresponding to each of the realization candidate data as the result of the input. The decision boundary is a conditional expression string in which, among conditional expressions indicating that a certain attribute is greater than or smaller than a threshold value, conditional expressions referred to when realization candidate data is input to the learning model are set.

The output unit 43 transmits the decision boundary acquired by the inferring unit 42 to the risk assessment apparatus 1. For example, the output unit 43 may transmit the decision boundary to the risk assessment apparatus 1 together with the identification information of the realization candidate data so that it can be determined which realization data the decision boundary is the result of calculation based on.

The output unit 43 may transmit information about the machine learning model other than those illustrated above to the risk assessment apparatus 1. Moreover, not limited to when transmitting the decision boundary to the risk assessment apparatus 1, the output unit 43 may transmit at any timing information about the machine learning model, namely, the decision tree, for example, information about the decision boundary to the risk assessment apparatus 1.

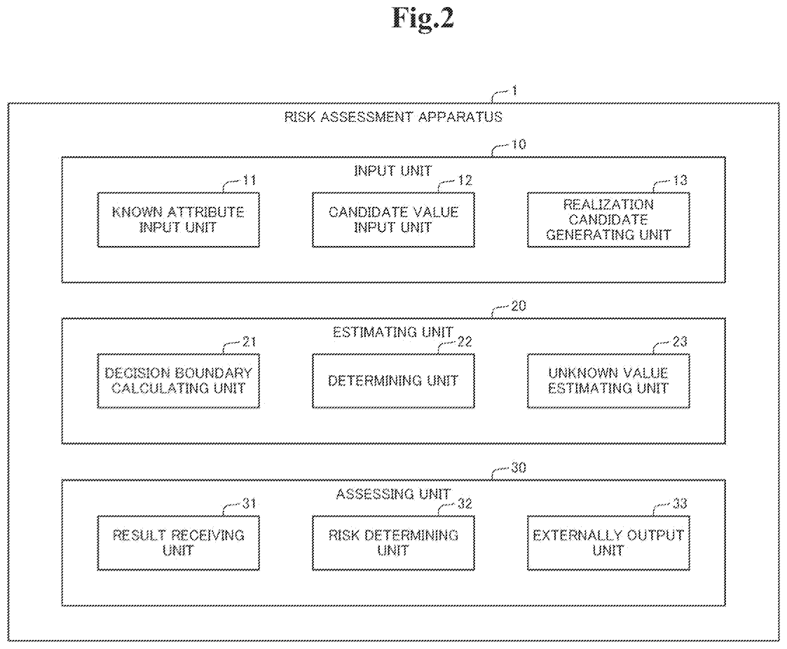

Next, the configuration of the risk assessment apparatus 1 will be described. The risk assessment apparatus 1 is configured with one or a plurality of information processing apparatuses each including an arithmetic logic unit and a memory unit. Then, as shown in FIG. 2, the risk assessment apparatus 1 includes an input unit 10, an estimating unit 20, and an assessing unit 30. The respective functions of the input unit 10, the estimating unit 20, and the assessing unit 30 can be realized by the arithmetic logic unit executing a program for realizing the respective functions stored in the memory unit. The input unit 10 includes a known attribute input unit 11, a candidate value input unit 12, and a realization candidate generating unit 13. The estimating unit 20 includes a decision boundary calculating unit 21, a determining unit 22, and an unknown value estimating unit 23. The assessing unit 30 includes a result receiving unit 31, a risk determining unit 32, and an externally output unit 33. Below, the respective components will be described in detail.

First, the input unit 10 accesses the database 3, acquires target data that is the pair of a value of a known attribute (first attribute value) to be an explanatory variable and a candidate value of an unknown value of a target attribute (second attribute value) to be an explanatory variable, and inputs the respective values to the known attribute input unit 11 and the candidate value input unit 12. In the following description, “age” and “annual income” are assumed to be explanatory variables as in the example of the decision tree described above, and target data will be acquired as the pair of the value of “age” that is the known attribute and the candidate value of the unknown value of “annual income” that is the target variable. Then, the realization candidate generating unit 13 generates realization candidate data based on the value of the known attribute and the candidate value of the unknown value of the target attribute, and transmits to the estimating unit 20. Herein, the realization candidate data is data in which the unknown value of the target attribute of the target data is temporarily placed with given candidate values. As an example, in the case of data corresponding to the example of the decision tree described above, assuming that the value of the known attribute is “age=40” and the candidate value of the unknown value of the target attribute has either “annual income=less than 5 million yen” or “annual income=5 million yen or more” in a binary category as the value, the realization candidate data of the target data are two data [“age=40”, “annual income=less than 5 million yen”] and [“age=40”, “annual income=5 million yen or more”].

The decision boundary calculating unit 21 of the estimating unit 20 calculates a decision boundary used when the realization candidate data generated by the realization candidate generating unit 13 described above is input to the decision tree that is the machine learning model stored in the model storage apparatus 2. At this time, the decision boundary calculating unit 21 may acquire the decision tree shown in FIG. 4 and the data of the decision boundary shown in FIG. from the memory unit and the model storage apparatus 2, or may, as described above, transmit the realization candidate data to the model storage apparatus 2, acquire data about the decision boundary based on the estimation result from the model storage apparatus 2, and generate the decision boundary.

The determining unit 22 of the estimating unit 20 determines the validity of the value of the unknown attribute based on the shape of the decision boundary. Specifically, the determination method by the determining unit 22 is, for example, determining whether or not a threshold value included by a conditional expression stored in a condition node string (condition path) through which the realization candidate data is allocated and passes in a decision tree matches the value of the known attribute of the realization candidate data. Then, when the value of the known attribute of the realization candidate data matches the threshold value, the determining unit 22 determines that the realization candidate data is not valid as training data, and excludes the candidate value temporarily placed as the target attribute from the result of attribute inference. On the other hand, when the value of the known attribute of the realization candidate data does not match and is different from the threshold value, the determining unit 22 determines that the realization candidate data is valid as training data, and transmits the candidate value temporarily placed as the target attribute of the realization candidate data to the unknown value estimating unit 23.

Here, the reason for using the abovementioned determination method will be explained. According to an algorithm when a decision tree learns, namely, a training algorithm, the threshold value of a conditional branch is set to the middle of the attribute values of two data that have different sort determinations. From this, if there is even one training data in which the value of a certain attribute x is t, when the attribute x is selected as a result of attribute selection for a conditional branch stored in a condition node to which the training data is allocated, it can be found that the corresponding branch threshold value cannot be t. That is to say, assuming that the set of attribute values of certain input data appears in the threshold value of a conditional expression stored in a conditional path to which the data is allocated, it is concluded that the data is not training data. Therefore, among realization candidate data of target data, those in which the set of attribute values of the realization candidate data appears in the threshold value of the conditional expression stored in the condition node on the condition path to which the realization candidate data is allocated do not match the target data itself that is training data, so that the candidate value temporarily placed as the target attribute of the realization candidate data can be excluded from the result of attribute inference.

For example, an example of determination in a case where the decision tree as shown in FIG. 4 described above is trained will be described with reference to FIG. 6. Herein, as described above, the value of a known attribute shall be “age=40”, and realization candidate data for the target data shall be two data of [“age=40”, “annual income=less than 5 million yen”] and [“age=40”, “annual income=5 million yen or more”]. In this case, training data cannot be allocated to a condition node storing a branch condition “age≥40”, that is, a node of a conditional branch including a threshold value “age=40”. That is to say, training data cannot pass through a condition node of “x₁≥5M”→“True”→ “x₂≥40”, which is indicated by a cross mark in FIG. 6. Therefore, it can be seen that it is allocated from the previous condition node (parent node) of “x₂≥40” to the other subsequent node (child node), namely, “x₁≥5M”→ “False”→ “x₂≥70”, which is indicated by a circle mark in FIG. 6. Thus, the realization candidate data [“age=40”, “annual income=5 million yen or more”] cannot be training data and is not a correct realization of the target data, so that it can be concluded that “annual income=5 million yen or more” is mismatching as the result of the attribute inference. On the other hand, realization candidate data in which the value of the known attribute “age=40” is different from the threshold value of the condition node, that is, [“age=40”, “annual income=less than 5 million yen”] is determined to be valid as training data, and “annual income=less than 5 million yen” is processed as the result of the attribute inference.

In a realistic setting, the number of realization candidates that clear the above determination can be expected to be small, so that highly accurate attribute inference can be achieved by outputting target attribute values corresponding to the realization candidates that clear the above determination. This is explained as follows. In the realistic setting, in order to obtain a highly accurate machine learning model, an ensemble model is built by combining a plurality of decision trees that recursively combine condition nodes. As the recursiveness of condition nodes and the number of decision trees used for ensemble learning increase, the shape of the decision boundaries of the ensemble model becomes more complex. Therefore, the probability that the value of the known attribute of data having not existed at the time of training matches the branch threshold value increases, and it can be expected that the number of realization candidate data that clears the above determination decreases.

Further, another criterion for determination by the determining unit 22 that an unknown candidate value of a target attribute of realization candidate data is valid as training data may be, in place of a case where the value of the known attribute does not match the threshold value, a case where the value of the known attribute is outside a predetermined range with reference to the threshold value. That is to say, in a case where the value of the known attribute is away more than a predetermined distance from the threshold value, the determining unit 22 may determine that the realization candidate data is valid as training data and, on the other hand, in a case where the distance between the value of the known attribute and the threshold value is equal to or less than a determined range (rejection range), may determine that the realization candidate data is not valid as training data.

The reason for determining in the above manner is that data that is farther from a decision boundary defined by a threshold value has a higher probability of being training data having actually existed than data that is closer to the decision boundary. The reason for this can be explained as follows. The threshold value of a conditional branch is determined at the middle of attribute values of two data that have different sorting determinations. Therefore, at each node after the branch, there is only one data closest to the threshold value, and the data other than the above data are all away from the boundary. In other words, it can be seen that the majority of the training data within the node is far from the boundary. That is to say, by replacing the condition of matching the threshold value by the determining unit with the condition of being within the rejection range, it is possible to narrow down realization candidates to a smaller number under stricter condition, and the possibility that actually existing training data can be selected increases.

For example, in the above example, when the abovementioned “rejection range=1” is set, realization candidate data in which the value of the known attribute is “age=39” is within the rejection range of the threshold value of the branch condition “age≥40”, so that the realization candidate data does not clear the determination and is excluded. In this case, when the rejection range is set larger, more realization candidate data are excluded, but there is also the possibility that realization candidate data that is valid as training data is also excluded. On the other hand, when the rejection range is set smaller, realization candidate data that is valid as training data is more likely to be left, but many other realization candidate data may also be left. Therefore, the value of the rejection range can be set to any real value of 0 or more so that various attackers can be assumed during risk assessment.

The unknown value estimating unit 23 determines the value of an unknown attribute based on a candidate value for the unknown attribute in the realization candidate data determined to be valid as training data by the determining unit 22. Then, the unknown value estimating unit 23 transmits the estimated value of the unknown attribute as an estimation value to the assessing unit 30. For example, the unknown value estimating unit 23 may estimate all candidate values for the unknown attribute corresponding to the realization candidate data determined to be valid as training data, as the values of the unknown attribute, and transmit to the assessing unit 30.

On the other hand, the candidate value for the unknown attribute having cleared the determination by the determining unit 22 described above and transmitted to the unknown value estimating unit 23 generally allows a plurality of possibilities, and the result of estimation of the attribute value is not unique. For this reason, the unknown value estimating unit 23 can select the most probable value as training data from these candidate values based on a predetermined selection criterion and transmit a unique selection result as the estimation value of the unknown value of the target attribute to the assessing unit 30.

Here, as an example of the selection criterion, the distance between the value of the known attribute and the threshold value appearing in the conditional expression on the conditional path of the decision tree is used. As described above, data that is away from the decision boundary is more probable to be training data having actually existed than data that is close to the decision boundary. Therefore, for the realization candidates, the distance between the value of the known attribute and the threshold value appearing in the conditional expression on the conditional path of the decision tree is calculated, the one with the largest distance is selected, and the selected result is output as the estimation value of the unknown attribute.

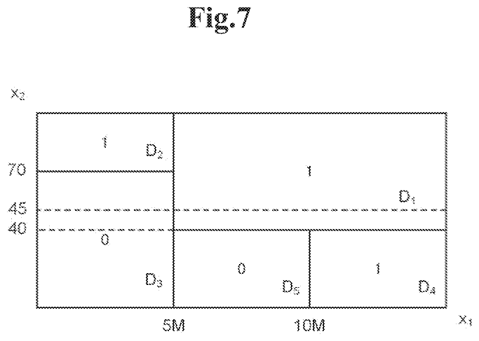

For example, in the above example, in a case where the known attribute of realization candidate data determined to be valid as training data is “age=45”, the realization candidate data is allocated to a partial region D₁ or D₃ of the explanatory variable space in decision boundaries shown in FIG. 7. That is to say, the unknown candidate value of the target attribute is “annual income=5 million yen or more” or “annual income=less than 5 million yen”. At this time, the decision boundaries of the known attribute “age” are “70” and “40”, so that the distances from the respective decision boundaries are “25” and “5”. Among them, the realization candidate data allocated to D₁ that is farther away from the value of the known attribute clears the determination, and “annual income=less than 5 million yen” that is a corresponding candidate value of the target attribute is output as the estimation value. In a case where a plurality of attributes are given as known attributes, the distance from the decision boundary may be calculated for each of the known attributes, and then the sum obtained by appropriately adding them may be used for comparison. For example, the Lp norm may be used as the addition method.

Here, the distance may be appropriately corrected in consideration of the fact that the units vary with attribute. This will be explained using an example of medical data. A case will be assumed where as a result of the branch, at a certain node, the range of a weight attribute has a magnitude of about two digits, such as between 50 and 60, while a blood oxygen level attribute has a magnitude of decimal places, such as between 0.98 and 1.00. In this case, it is expected that the threshold distance becomes extremely larger for the weight attribute than for the blood oxygen level attribute and accurate attribute inference becomes difficult as the magnitude of the threshold distance cannot be assessed correctly. Therefore, a correction is made by dividing the threshold distance by the width of the range for each attribute. For example, in the example of medical data, the threshold distance is multiplied by one-tenth for the weight attribute and multiplied by 50 for the blood oxygen level attribute. Consequently, the value range of each attribute is corrected to a width of 1, and it can be expected that accurate attribute inference will be possible by assessment of the threshold distance without being biased toward each attribute. In a case where there is no upper or lower limit for any of the decision boundaries, that is, in a case where the decision boundaries are expressed using ∞ (infinity) or −∞, a correction is performed after the real number line is transformed into a finite interval (e.g., interval of-1 or more to 1 or less) by an appropriate function.

Note that it is possible to select one estimation value from unknown candidate values for the target attribute by, not limited to the method described above, but using the techniques disclosed in Non-Patent Literature 1 and Non-Patent Literature 2. For example, it is possible to, after limiting the candidate values for the target attribute to those corresponding to realization candidate data determined to be valid as training data, execute the attribute inference described in Non-Patent Literature 1 and select only one. However, in this case, it is necessary to assume at least one of true label information and marginal distribution information. In contrast, the above example embodiment has the advantage that selection can be made without assuming either true label information or marginal distribution information.

The result receiving unit 31 of the assessing unit 30 receives the estimation value of the unknown attribute transmitted by the unknown value estimating unit 23, and transmits to the risk determining unit 32. The risk determining unit 32 compares the estimation value of the unknown attribute received from the result receiving unit 31 with the original value of the attribute stored in the database 3 and, based on this, calculates a predetermined risk assessment value corresponding to a risk of leakage of training data and the like, and transmits to the externally output unit 33. The externally output unit 33 transmits an output result to an external output device.

### [Operation]

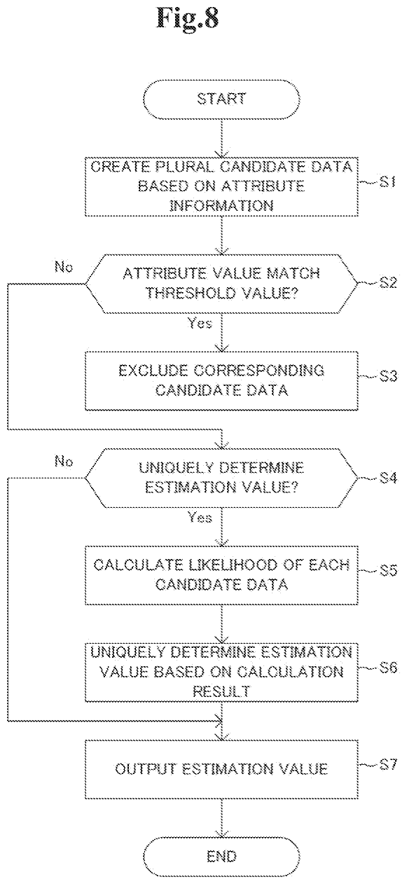

Next, the operation of the abovementioned risk assessment apparatus 1 will be described mainly with reference to a flowchart of FIG. 8. Here, the target is a machine learning model composed of a decision tree having the structure shown in FIG. 4 described above.

First, the risk assessment apparatus 1 acquires target data that is the pair of a value of a known attribute to be an explanatory variable and a candidate value for a unknown value of a target variable to be an explanatory variable, and generates realization candidate data. For example, as described above, in a case where the value of a known attribute is “age=40” and a candidate value for an unknown value of a target variable is either “annual income=less than 5 million yen” or “annual income=5 million yen or more”, the risk assessment apparatus 1 generates two realization candidate data; [“age=40”, “annual income=less than 5 million yen”] and [“age=40”, “annual income=5 million yen or more”].

Subsequently, the risk assessment apparatus 1 determines the validity of the realization candidate data as training data based on the decision boundary of the decision tree. For example, the risk assessment apparatus 1 determines whether or not a threshold value included by a conditional expression stored in a condition node string (conditional path) where the realization candidate data is allocated and passes in the decision tree matches the value of the known attribute of the realization candidate data (step S2). Then, in a case where the value of the known attribute of the realization candidate data matches the threshold value (Yes at step S2), the risk assessment apparatus 1 determines that the realization candidate data is not valid as training data and excludes from an attribute inference result (step S3). On the other hand, in a case where the value of the known attribute of the realization candidate data does not match the threshold value, the risk assessment apparatus 1 determines that the realization candidate data is valid as training data (No at step S2). For example, in the case of the realization candidate data described above, as shown in FIG. 6, the realization candidate data [“age=40”, “annual income=5 million yen or more”] is determined to be invalid as training data, and the realization candidate data [“age=40”, “annual income=less than 5 million yen”] is determined to be valid as training data.

Meanwhile, the risk assessment apparatus 1 may determine the validity of realization candidate data as training data by a method other than the above method. For example, the risk assessment apparatus 1 may use a condition that “the value of the known attribute is within a predetermined range with reference to the threshold value” at step S2. Then, the risk assessment apparatus 1 determines that the realization candidate data is not valid and excludes (Yes at step S2, step S3) in a case where the value of the known attribute is within the predetermined range with reference to the threshold value (Yes at step S2), and determines that the realization candidate data is valid in a case where the value of the known attribute is not within the predetermined range with reference to the threshold value (No at step S2).

Subsequently, in the case of uniquely determining an estimation value of the unknown value of the target attribute (Yes at step S4), the risk assessment apparatus 1 estimates a value of the target attribute corresponding to one of the realization candidate data determined to be valid as training data, as the estimation value. For example, the risk assessment apparatus 1 calculates the likelihood of each of the realization candidate data using the distance between the value of the known attribute of the realization candidate data and the threshold value appearing in the conditional expression on the conditional path of the decision tree as described above (step S5), and determines one estimation value based on the calculation result (step S6). Then, the risk assessment apparatus 1 outputs the determined estimation value of the target attribute (step S7). In the case of not uniquely determining the estimation value of the target attribute (No at step S4), the risk assessment apparatus 1 estimates and outputs the candidate values of the target attribute of all the realization candidate data determined to be valid as training data, as the estimation values (step S7).

### Second Example Embodiment

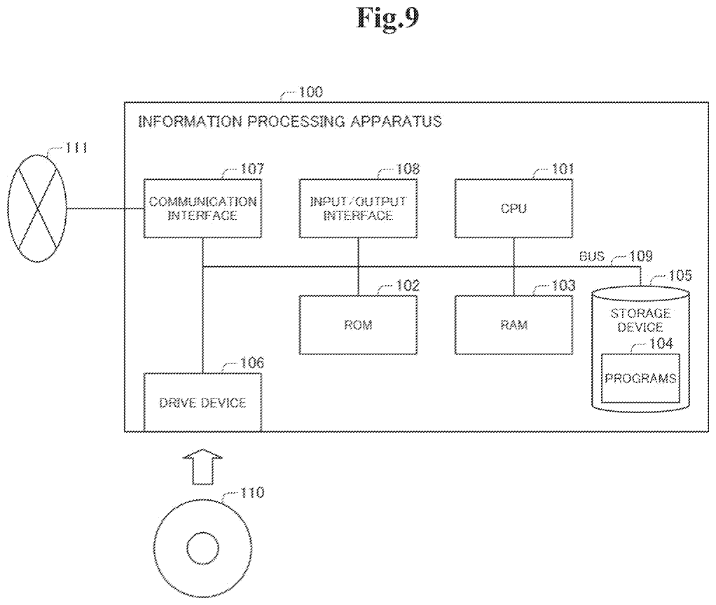

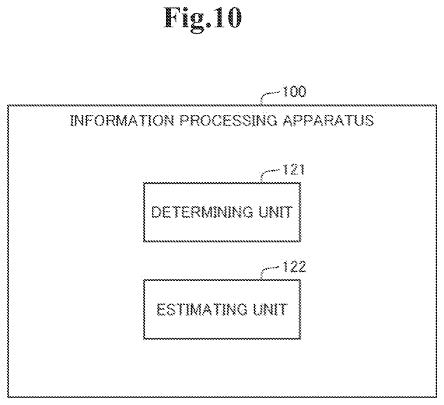

Next, a second example embodiment of the present disclosure will be described with reference to FIGS. 9 and 10. FIGS. 9 and 10 are block diagrams showing the configuration of an information processing apparatus in the second example embodiment. In this example embodiment, the overview of the configuration of the risk assessment apparatus described in the above example embodiment is shown.

First, the hardware configuration of an information processing apparatus 100 in this example embodiment will be described with reference to FIG. 9. The information processing apparatus 100 is configured with a general information processing apparatus and, as an example, has the following hardware configuration including;
a CPU (Central Processing Unit) 101 (arithmetic logic unit),
a ROM (Read Only Memory) 102 (memory unit),
a RAM (Random Access Memory) 103 (memory unit),
programs 104 loaded to the RAM 103,
a storage device 105 that stores the programs 104,
a drive device 106 that reads from and writes into a storage medium 110 outside the information processing apparatus,
a communication interface 107 connected to a communication network 111 outside the information processing apparatus,
an input/output interface 108 that inputs and outputs data, and
a bus 109 that connects the components.

FIG. 9 shows an example of the hardware configuration of the information processing apparatus serving as the information processing apparatus 100, and the hardware configuration of the information processing apparatus is not limited to the above case. For example, the information processing apparatus may be configured with part of the above configuration, such as not having the drive device 106. Moreover, the information processing apparatus may include, instead of the CPU mentioned above, a GPU (Graphic Processing Unit), a DSP (Digital Signal Processor), an MPU (Micro Processing Unit), an FPU (Floating Point Unit), a PPU (Physics Processing Unit), a TPU (Tensor Processing Unit), a quantum processor, a microcontroller, a combination thereof, or the like.

Then, the information processing apparatus 100 can build and include a determining unit 121 and an estimating unit 122 shown in FIG. 10 by the CPU 101 acquiring and executing the programs 104. The programs 104 are, for example, stored in advance in the storage device 105 or the ROM 102, and loaded to the RAM 103 and executed by the CPU 101 as necessary. The programs 104 may be supplied to the CPU 101 via the communication network 111, or may be stored in advance in the storage medium 110 and read and supplied by the drive device 106 to the CPU 101. However, the determining unit 121 and the estimating unit 122 described above may be built by a dedicated electronic circuit for implementing such means.

The determining unit 121 determines, based on a decision boundary of a machine learning model relating to a first attribute value and a second attribute value input to the machine learning model and on target data that is the pair of a known value of the first attribute value and an unknown candidate value of the second attribute value, whether the target data is valid as training data for the machine learning model. For example, the determining unit 121 determines whether the target data is valid, based on a boundary value corresponding to the first attribute value in the decision boundary based on the content of a conditional branch of a decision tree serving as the machine learning model and on the known value of the first attribute value.

The estimating unit 122 estimates a value of the second attribute value, from the candidate value of the second attribute value included by the target data determined to be valid.

According to the configuration of the present disclosure as described above, since the unknown value is estimated in consideration of the decision boundary of the machine learning model, a correct risk assessment assuming an attack of an intensity that should be assumed originally for the machine learning model can be performed.

The abovementioned program can be stored using various types of non-transitory computer-readable mediums and supplied to a computer. The non-transitory computer-readable mediums include various types of tangible storage mediums. Examples of the non-transitory computer-readable mediums include a magnetic recording medium (e.g., flexible disk, magnetic tape, hard disk drive), a magneto-optical recording medium (e.g., magneto-optical disk), a CD-ROM (Read Only Memory), a CD-R, a CD-R/W, and a semiconductor memory (e.g., mask ROM, PROM (Programmable ROM), EPROM (Erasable PROM), flash ROM, RAM (Random Access Memory)). Moreover, the program may be supplied to a computer by various types of transitory computer-readable mediums. Examples of the transitory computer-readable mediums include an electric signal, an optical signal, and an electromagnetic wave. The transitory computer-readable mediums can supply the program to a computer via a wired communication path such as an electric wire and an optical fiber or via a wireless communication path.

Although the present disclosure has been described above with reference to the example embodiments, the present disclosure is not limited to the above example embodiments. The configurations and details of the present disclosure can be changed in various manners that can be understood by one skilled in the art. Moreover, at least one or more functions of the determining unit 121 and the estimating unit 122 described above may be executed by an information processing apparatus installed at any place on the network and connected, that is, may be executed on so-called cloud computing.

### SUPPLEMENTARY NOTES

The whole or part of the example embodiments disclosed above can be described as the following supplementary notes. The overview of the configurations of an information processing apparatus, an information processing method, and a program in the present disclosure will be described below. However, the present disclosure is not limited to the following configurations.

### (Supplementary Note 1)

An information processing apparatus comprising:
a determining unit that determines, based on a decision boundary of a machine learning model that relates to a first attribute value and a second attribute value input to the machine learning model and on target data including a pair of a known value of the first attribute value and an unknown candidate value of the second attribute value, whether the target data is valid as training data for the machine learning model; and
an estimating unit that estimates a value of the second attribute value from the candidate value of the second attribute value included by the target data determined to be valid.

### (Supplementary Note 2)

The information processing apparatus according to Supplementary Note 1, wherein
the determining unit determines whether the target data is valid based on a boundary value corresponding to the first attribute value in the decision boundary based on a content of a conditional branch of a decision tree model serving as the machine learning model and on the known value of the first attribute value.

### (Supplementary Note 3)

The information processing apparatus according to Supplementary Note 2, wherein
the determining unit determines, for each of a plurality of the target data including same known values of the first attribute value and different unknown candidate values of the second attribute value, whether the target data is valid based on comparison between a threshold value of a conditional expression included by the conditional branch and the known value of the first attribute value included by the target data.

### (Supplementary Note 4)

The information processing apparatus according to Supplementary Note, wherein
the determining unit determines that the target data is valid in a case where the threshold value of the conditional expression included by the condition branch of the decision tree model on a path through which the target data passes in the conditional branch and the known value of the first attribute value included by the target data are different from each other.

### (Supplementary Note 5)

The information processing apparatus according to Supplementary Note 3 or 4, wherein
the determining unit determines that the target data is valid in a case where the known value of the first attribute value is outside a predetermined range with reference to the threshold value of the conditional expression included by the condition branch of the decision tree model on a path through which the target data passes in the conditional branch.

### (Supplementary Note 6)

The information processing apparatus according to any of Supplementary Notes 3 to 5, wherein
the estimating unit estimates the value of the second attribute value from the candidate value of the second attribute value of the target data determined to be valid, based on the known value of the first attribute value paired with the candidate value of the second attribute value and on the decision boundary.

### (Supplementary Note 7)

The information processing apparatus according to Supplementary Note 6, wherein
the estimating unit estimates the value of the second attribute value from the candidate value of the second attribute value of the target data determined to be valid, based on a distance between the known value of the first attribute value paired with the second attribute value and the threshold value of the conditional expression included by the conditional branch.

### (Supplementary Note 8)

The information processing apparatus according to Supplementary Note 7, wherein
the estimating unit estimates, as the value of the second attribute value, the candidate value of the second attribute value paired with the known value of the first attribute value having a largest distance from the threshold value of the conditional expression included by the conditional branch from among the candidate values of the second attribute value of the target data determined to be valid.

### (Supplementary Note 9)

An information processing method comprising:
determining, based on a decision boundary of a machine learning model that relates to a first attribute value and a second attribute value input to the machine learning model and on target data including a pair of a known value of the first attribute value and an unknown candidate value of the second attribute value, whether the target data is valid as training data for the machine learning model; and
estimating a value of the second attribute value from the candidate value of the second attribute value included by the target data determined to be valid.

### (Supplementary Note 9.1)

The information processing method according to Supplementary Note 9, comprising
determining whether the target data is valid based on a boundary value corresponding to the first attribute value in the decision boundary based on a content of a conditional branch of a decision tree model serving as the machine learning model and on the known value of the first attribute value.

### (Supplementary Note 9.2)

The information processing method according to Supplementary Note 9.1, comprising
determining, for each of a plurality of the target data including same known values of the first attribute value and different unknown candidate values of the second attribute value, whether the target data is valid based on comparison between a threshold value of a conditional expression included by the conditional branch and the known value of the first attribute value included by the target data.

### (Supplementary Note 9.3)

The information processing method according to Supplementary Note 9.2, comprising
estimating the value of the second attribute value from the candidate value of the second attribute value of the target data determined to be valid, based on the known value of the first attribute value paired with the candidate value of the second attribute value and on the decision boundary.

### (Supplementary Note 9.4)

The information processing method according to Supplementary Note 9.3, comprising
estimating the value of the second attribute value from the candidate value of the second attribute value of the target data determined to be valid, based on a distance between the known value of the first attribute value paired with the second attribute value and the threshold value of the conditional expression included by the conditional branch.

### (Supplementary Note 10)

A computer program comprising instructions for causing a computer to execute processes to:
determine, based on a decision boundary of a machine learning model that relates to a first attribute value and a second attribute value input to the machine learning model and on target data including a pair of a known value of the first attribute value and an unknown candidate value of the second attribute value, whether the target data is valid as training data for the machine learning model; and
estimate a value of the second attribute value from the candidate value of the second attribute value included by the target data determined to be valid.

### DESCRIPTION OF REFERENCE NUMERALS

1 risk assessment apparatus
2 model storage apparatus
3 database
10 input unit
11 known attribute input unit
12 candidate value input unit
13 realization candidate generating unit
20 estimating unit
21 decision boundary calculating unit
22 determining unit
23 unknown value estimating unit
30 assessing unit
31 result receiving unit
32 risk determining unit
33 externally output unit
41 receiving unit
42 inferring unit
43 output unit
44 machine learning model storing unit
100 information processing apparatus
101 CPU
102 ROM
103 RAM
104 programs
105 storage device
106 drive device
107 communication interface
108 input/output interface
109 bus
110 storage medium
111 communication network
121 determining unit
122 estimating unit

1. An information processing apparatus comprising:
a memory storing processing instructions; and
at least one processor configured to execute the processing instructions to:
determine, based on a decision boundary of a machine learning model that relates to a first attribute value and a second attribute value input to the machine learning model and on target data including a pair of a known value of the first attribute value and an unknown candidate value of the second attribute value, whether the target data is valid as training data for the machine learning model; and
estimate a value of the second attribute value from the candidate value of the second attribute value included by the target data determined to be valid.

2. The information processing apparatus according to claim 1, wherein the at least one processor is configured to execute the processing instructions to
determine whether the target data is valid based on a boundary value corresponding to the first attribute value in the decision boundary based on a content of a conditional branch of a decision tree model serving as the machine learning model and on the known value of the first attribute value.

3. The information processing apparatus according to claim 2, wherein the at least one processor is configured to execute the processing instructions to
determine, for each of a plurality of the target data including same known values of the first attribute value and different unknown candidate values of the second attribute value, whether the target data is valid based on comparison between a threshold value of a conditional expression included by the conditional branch and the known value of the first attribute value included by the target data.

4. The information processing apparatus according to claim 3, wherein the at least one processor is configured to execute the processing instructions to
determine that the target data is valid in a case where the threshold value of the conditional expression included by the condition branch of the decision tree model on a path through which the target data passes in the conditional branch and the known value of the first attribute value included by the target data are different from each other.

5. The information processing apparatus according to claim 3, wherein the at least one processor is configured to execute the processing instructions to
determine that the target data is valid in a case where the known value of the first attribute value is outside a predetermined range with reference to the threshold value of the conditional expression included by the condition branch of the decision tree model on a path through which the target data passes in the conditional branch.

6. The information processing apparatus according to claim 3, wherein the at least one processor is configured to execute the processing instructions to
estimate the value of the second attribute value from the candidate value of the second attribute value of the target data determined to be valid, based on the known value of the first attribute value paired with the candidate value of the second attribute value and on the decision boundary.

7. The information processing apparatus according to claim 6, wherein the at least one processor is configured to execute the processing instructions to
estimate the value of the second attribute value from the candidate value of the second attribute value of the target data determined to be valid, based on a distance between the known value of the first attribute value paired with the second attribute value and the threshold value of the conditional expression included by the conditional branch.

8. The information processing apparatus according to claim 7, wherein the at least one processor is configured to execute the processing instructions to
estimate, as the value of the second attribute value, the candidate value of the second attribute value paired with the known value of the first attribute value having a largest distance from the threshold value of the conditional expression included by the conditional branch from among the candidate values of the second attribute value of the target data determined to be valid.

9. An information processing method comprising:
determining, based on a decision boundary of a machine learning model that relates to a first attribute value and a second attribute value input to the machine learning model and on target data including a pair of a known value of the first attribute value and an unknown candidate value of the second attribute value, whether the target data is valid as training data for the machine learning model; and
estimating a value of the second attribute value from the candidate value of the second attribute value included by the target data determined to be valid.

10. The information processing method according to claim 9, comprising
determining whether the target data is valid based on a boundary value corresponding to the first attribute value in the decision boundary based on a content of a conditional branch of a decision tree model serving as the machine learning model and on the known value of the first attribute value.

11. The information processing method according to claim 10, comprising
determining, for each of a plurality of the target data including same known values of the first attribute value and different unknown candidate values of the second attribute value, whether the target data is valid based on comparison between a threshold value of a conditional expression included by the conditional branch and the known value of the first attribute value included by the target data.

12. The information processing method according to claim 11, comprising
estimating the value of the second attribute value from the candidate value of the second attribute value of the target data determined to be valid, based on the known value of the first attribute value paired with the candidate value of the second attribute value and on the decision boundary.

13. The information processing method according to claim 12, comprising
estimating the value of the second attribute value from the candidate value of the second attribute value of the target data determined to be valid, based on a distance between the known value of the first attribute value paired with the second attribute value and the threshold value of the conditional expression included by the conditional branch.

14. A non-transitory computer-readable storage medium storing a program, the program comprising instructions for causing a computer to execute processes to:
determine, based on a decision boundary of a machine learning model that relates to a first attribute value and a second attribute value input to the machine learning model and on target data including a pair of a known value of the first attribute value and an unknown candidate value of the second attribute value, whether the target data is valid as training data for the machine learning model; and
estimate a value of the second attribute value from the candidate value of the second attribute value included by the target data determined to be valid.
